(19) United States
(12) Patent Application Publication
(10) Pub. No.: US 2008/0115805 A1
(43) Pub. Date: May 22, 2008

(54) Device for removing stray fibers from a shade fabric edge

(76) Inventor: David A. Kirby, Zlonsville, PA (US)

Correspondence Address: Drinker Biddle & Reath LLP, Patent Docketing;One Logan Square, 18th and Cherry Streets, Philadelphia, PA, 19103-6996, US

(21) Appl. No.: 11/985,106

(22) Filed: Nov. 14, 2007

Related U.S. Application Data
(60) Provisional application No. 60/859,318, filed on Nov. 16, 2006.

(51) Int. Cl. B08B 7/04; A46B 13/00

(52) U.S. Cl. 134/6; 15/4; 15/88.2

(57) ABSTRACT

A device for removing stray fibers from a shade fabric includes a fabric teaser adapted to loosen fibers along an edge of the fabric and fiber cutters adapted to remove stray fibers from the shade fabric. The fabric teaser comprises first and second rotary brushes each having a brush element. The brush elements of the first and second rotary brushes are adapted to receive the edge of the shade fabric between the brush elements and to rotate in opposite rotational directions for loosening the stray fibers along the edge of the shade fabric. According to one embodiment, the fiber cutters include reciprocating cutting elements and the fabric teaser includes rotary brushes having radially-extending bristles arranged to receive the shade fabric between the bristles. The device may include a mounting bracket for adjustably mounting the fabric teaser and fiber cutters on an elongated rail.

### CROSS-REFERENCE TO RELATED APPLICATION

This application claims priority from U.S. provisional application No. 60/859,318, filed Nov. 16, 2006, the entire disclosure of which is hereby incorporated by reference.

### FIELD OF THE INVENTION

The present invention relates to shade fabrics used with roller shades and, more particularly, to a device for teasing out and removing stray fibers from cut edges of the shade fabric.

### BACKGROUND

Certain fabrics, particularly fabrics made with polyvinyl chloride-coated (PVC-coated) fiberglass or polyester yarn tend to fray along edges of the fabric when the fabric is cut. Such fraying typically results when fibers that are substantially aligned with the cut edge are no longer constrained by adjacent fibers (e.g., by the orthogonal weave of the fabric). The released fibers tend to move outwardly (i.e., stray) from the cut edge into an exposed or “frayed” position. Referring to FIG. 1, there is shown an enlargement of a shade fabric 2 made from PVC-coated fibers. The shade fabric 2 has been cut to define an edge 4. The cutting of the shade fabric 2 resulted in the release of fibers 6 extending substantially along the cut edge 4 of the shade fabric 2 that were previously constrained within the fabric matrix. As shown, the released fibers 6 spring outwardly into a frayed condition with respect to the cut edge 4.

This condition of unconstrained frayed fibers along a cut fabric edge is particularly problematic along the vertical edges of a roller shade fabric because these edges are typically visible from the shaded space (e.g., the interior of a room) when the shade fabric is lowered from the roller. In addition, the fraying of unconstrained fibers along the edges of a shade fabric tends to worsen over time because a shade fabric is not held in a static position. The movement of the shade fabric to and from a rolled condition on the roller of a shade roller, and the associated contact between adjacent portions of the material, results in increased fraying of fibers along the edges of the shade fabric.

Stray fibers along the edges of roller shade fabrics have been removed in the field (i.e., at the installed location) by hand using various instruments such as scissors or trimmers. Removal by hand, however, is undesirably time consuming. In addition, a lack of control over the cutting or trimming instrument could damage the shade fabric resulting in a marred edge that is more unsightly than the originally frayed edge. Furthermore, subsequent use of the shade after stray fibers have been trimmed in the field will likely require additional treatment because the above-described shade movement and material contact will release additional fibers.

### SUMMARY OF THE INVENTION

According to the present invention, a device is provided for teasing out and also removing stray fibers from an edge of a shade fabric, particularly along a cut edge of the shade fabric. The device includes an edge teaser arranged to contact an edge portion of the shade fabric and adapted to loosen fibers adjacent the shade fabric edge for removal by a fiber cutter of the device.

According to one embodiment, the device includes upper and lower fiber cutters respectively located above and below the edge teaser. The fiber cutters include cutting elements, preferably reciprocating, located at the cutting ends of the fiber cutters. The fiber cutters are preferably mounted on holders that angle the fiber cutters obliquely with respect to the edge of the shade fabric and oppositely with respect to each other such that the upper fiber cutter is pointed downwardly and the lower fiber cutter is pointed upwardly.

According to one embodiment, the edge teaser includes first and second fiber-teasing members each including a rotatingly-mounted contact element arranged to provide contact between the shade fabric and a periphery of the contact element. The fiber-teasing members are preferably adapted to contact front and rear surfaces of the shade fabric. The contact members preferably include rotary brushes having radially-extending bristles.

Each of the fiber-teasing members includes a motor having an output shaft coupled to the associated contact member for rotatingly driving the contact member about a central axis of the contact member. Preferably, the motors are adapted to drive the contact elements of the first and second fiber-teasing members in opposite rotational directions with respect to each other.

According to one embodiment, the device is secured to a runner bracket that is slidably mounted on an elongated rail such that the device is vertically fixed and horizontally adjustable. The shade fabric is preferably secured to a motor-driven roller to raise and lower the shade fabric with respect to the device to facilitate treatment of an edge of the shade fabric by the device. Preferably, first and second devices are arranged on opposite sides of the shade fabric to provide for simultaneous treatment of the opposite edges of the shade fabric by the devices during movement of the shade fabric by the motor-driven roller.

### BRIEF DESCRIPTION OF THE DRAWINGS

FIG. 1 shows a cut edge of a shade fabric made from PVC-coated fibers showing unconstrained and frayed fibers along a cut edge of the shade fabric.

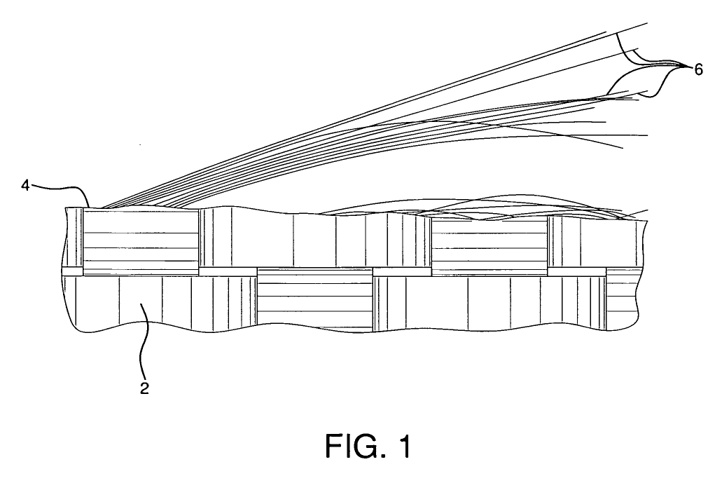

FIG. 2 is a perspective view of a device for removing stray fibers from a cut edge of a shade fabric according to an exemplary embodiment of the invention.

### DETAILED DESCRIPTION OF THE INVENTION

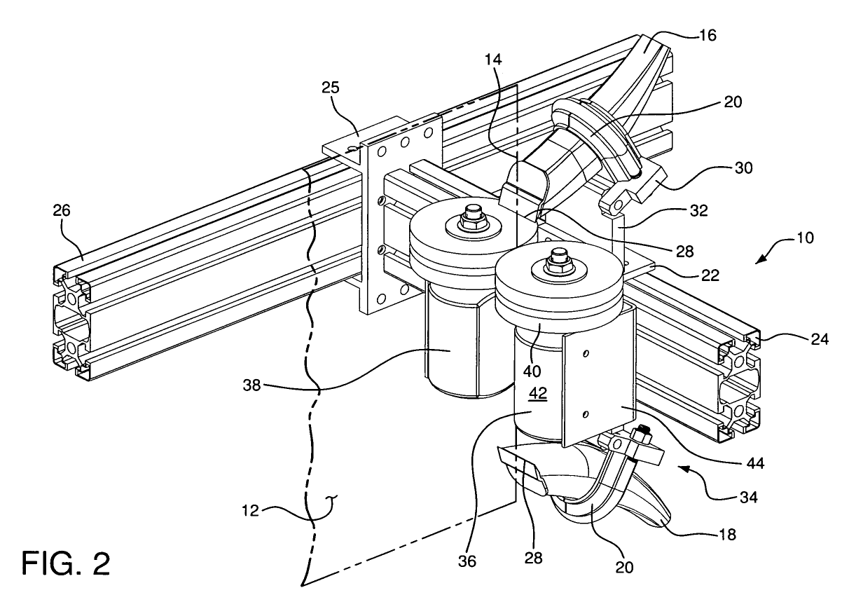

Referring to the photograph and drawings, where like numerals identify like elements, there is shown in FIG. 2 a device 10 for removing stray fibers from an edge 14 of a shade fabric 12 according to an exemplary embodiment of the invention. As described in greater detail below, the device provides for controlled removal of stray fibers from the edge of the shade fabric 12 desirably resulting in greater precision compared to removal by hand. In addition, the device 10 is also adapted to contact and tease the fibers along the edge. The teasing of the fibers along the edge of the shade fabric 12 releases fibers that would otherwise temporarily remain in place along the edge only to be released subsequently during use of the shade fabric. The device 10, therefore, is adapted to substantially eliminate the need for subsequent removal of stray fibers in the field, or to at least significantly increase the usage time for the shade fabric 12 before a need to remove fibers in the field results.

The device 10 includes first and second fiber cutters 16, 18 respectively located in upper and lower positions from the point of view shown in FIGS. 2 and 3. The fiber cutters 16, 18 are secured by cutter holders 20 to a runner bracket 22 that is mounted on an elongated track rail 24 such that the fiber cutters 16, 18 are respectively located above and below the track rail 24. The cutter holders 20 are preferably adapted to apply a clamping force to the associated fiber cutter 16, 18 to secure the fiber cutter to the runner bracket 22.

As should be understood by those skilled in the art, the runner bracket 22 and track rail 24 are preferably constructed such that the runner bracket 22 is slidably supported on the track rail 24 for adjusting the relative position of the runner bracket 22 on the track rail 24. As shown, the track rail 24 is secured to a runner bracket 25 that is mounted on a second track rail 26. The second track rail 26 is substantially perpendicular to the first track rail 24. This arrangement provides for adjustments to the position of the device 10 in both orthogonal directions within an x-y plane (i.e., horizontal plane).

The fiber cutters 16, 18 are received and supported by the cutter holders 20 such that a cutting end 28 of the fiber cutters 16, 18 is located adjacent the edge 14 of the shade fabric 12 for removing stray fibers from the edge 14. The cutter holders 20 are preferably adapted to provide for release of the clamping force applied to the associated fiber cutter 16, 18 for adjusting the relative position of the fiber cutter 16, 18 or for removing the fiber cutter 16, 18 for repair or replacement. As shown, each cutter holder 20 has a support 30 that is angled with respect to an upstanding plate 32 such that the associated fiber cutter 16, 18 is oriented obliquely with respect to the edge 14 of the shade fabric 12, which is substantially vertically oriented.

As also shown, the fiber cutters 16, 18 are reversed with respect to each other such that the upper fiber cutter 16 is pointed downwardly while the lower fiber cutter 18 is pointed upwardly. In this manner, the upper and lower fiber cutters complement each other in that the upper fiber cutter 16 will tend to contact and remove stray fibers that might otherwise be missed by the lower fiber cutter 18, and vice versa.

The cutting end 28 of the fiber cutters 16, 18 is shown schematically to facilitate illustration and to indicate that the invention is not limited to any particular kind of cutter. According to a presently preferred embodiment, however, the fiber cutters 16, 18 include reciprocating cutting elements at the cutting end 28 similar to the cutting elements included in clippers for cutting or trimming moustaches and beards. Preferably, the fiber cutters 16, 18 are powered by battery power. However, the fiber cutters 16, 18 could, alternatively, include power cords for connection to an external power source.

The device 10 includes an edge teaser assembly 34 including first and second fiber-teasing members 36, 38 located between the fiber cutters 16, 18. Each of the fiber-teasing members 36, 38 includes a rotatingly-mounted contact element 40 adapted to contact an edge portion of the shade fabric 12 at a periphery of the contact element 40. As shown, the contact elements 40 of the fiber-teasing members 36, 38 are arranged to respectively contact front and rear surfaces of the shade fabric 12. As described below in greater detail, the contact between the contact elements 40 and the edge portion of the shade fabric 12 tends to loosen fibers along the edge 14 that might otherwise remain in place absent the contact. In this manner, the edge teaser assembly 34 desirably allows the fiber cutters 16, 18 to remove stray fibers that would otherwise subsequently become loosened (i.e., stray) after the shade fabric 12 has been in service and used for some period of time.

The contact elements 40 of the fiber-teasing members 36, 38 are shown schematically to facilitate illustration and to indicate that the contact elements 40 are not limited to any particular construction. According to a presently preferred embodiment, however, the contact elements 40 comprise rotary brushes having closely spaced, radially-extending bristles. The bristles are preferably flexible in construction to provide for desired fiber-loosening agitation of the edge portions of the shade fabric 12 while limiting damage to the shade fabric 12.

Each of the fiber-teasing members 36, 38 includes a drive motor 42 having an output shaft coupled to the associated contact element 40 for rotatingly driving the contact element 40 about a central axis of the contact element. Preferably, a battery located within a housing of the motor 42 powers the motor 42. Similarly to the fiber cutters 16, 18, however, the motor 42 could, alternatively, include power cords for connecting the motors 42 to an external power source. The motor 42 for each of the fiber-teasing members 36, 38 is mounted to a bracket 44. The motor brackets 44 are secured to the runner bracket 22 of the device 10.

The drive motors 42 of the fiber-teasing members 36, 38 are preferably adapted to rotate the associated contact elements 40 of the fiber-teasing members 36, 38 in opposite rotational directions from each other. In this manner, tangential movement for the contact elements 40 at the point of contact with the shade fabric 12 will be in the same direction for both of the fiber-teasing members 36, 38. From the point of view shown in FIG. 2, the motors 42 for the first and second fiber-teasing members 36, 38 preferably rotate the associated contact elements 40 in a clockwise and a counter-clockwise direction, respectively, such that tangential movement at the point of contact with the shade fabric 12 is toward the right-hand side of the view (i.e., outwardly from the edge of the shade fabric).

For the depicted device 10 that is fixed vertically, the shade fabric 12 is moved vertically for teasing out and removing stray fibers. Preferably, the shade fabric 12 is moved vertically in an unrolled condition by raising and lowering a mounting device to which the shade fabric 12 is secured. Raising and lowering an unrolled shade fabric 12 as opposed to winding the shade fabric 12 onto a roller tube desirably limits lateral edge movements that might otherwise result from winding imperfections. This arrangement provides controlled movement of the shade fabric 12 with respect to the device 10 for fiber agitation by the edge teaser assembly 34 and cutting of stray fibers by the fiber cutters 16, 18 in a precise manner such that damage to the shade fabric edge 14 is limited. Although only one device 10 is shown, it is preferable to include first and second devices 10 located on opposite sides of the shade fabric 12. Such a construction provides for simultaneous treatment of both sides of the shade fabric 12 as the shade fabric 12 is raised and lowered.

Although raising and lowering the shade in an unrolled condition as described above is preferred, it is not required. The shade fabric 12 could alternatively be raised and lowered by securing the shade fabric 12 to a motor-driven roller for winding and unwinding the shade fabric. If the shade fabric 12 is secured to a motor-driven roller, it is desirable that the device 10 be located sufficiently close to the motor-driven roller so as to provide for treatment of a majority of the shade fabric 12 by the device 10. Some amount of separating distance between the device 10 and the motor-driven roller, however, is desirable. Such separating distance allows for a certain amount of winding imperfections to occur at the roller, and an associated lateral edge movement of the shade, while only limited lateral movement of the shade fabric edge 14 occurs at the location of the device 10. As discussed above, limiting the lateral movement of the shade fabric 12 at the location of the device 10 is desirable to promote controlled and uniform cutting of stray fibers along the edges of the shade fabric 12.

As described above, the depicted device 10 is fixed vertically while the shade fabric 12 is moved vertically (e.g., by raising and lowering the shade fabric in an unrolled condition) to provide for treatment of the shade fabric 12 by the device 10. The invention, however, is not so limited. It is conceivable that, alternatively, the device 10 could be mounted to a movable support that is adapted to raise and lower the device 10 vertically with respect to a fixed shade fabric 12 in order to treat the edges of the shade fabric.

As described above, the stray fibers along the edges of the shade fabric 12 are cut by the fiber cutters 16, 18 as the shade fabric 12 is moved vertically. However, the invention is not limited to the use of fiber cutters 16, 18 to automatically cut the stray fibers. Alternatively, the stray fibers could be manually cut using a cutting instrument, such as scissors or trimmers, after the shade fabric 12 has been moved up and down vertically and the fiber-teasing members 36, 38 have loosened the stray fibers.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A device for removing stray fibers from an edge of a shade fabric, the device comprising:
at least one fiber cutter adapted to remove the stray fibers from the shade fabric; and
a fabric teaser arranged to contact the shade fabric and adapted to loosen the stray fibers located along the edge of the shade fabric to facilitate removal of the fibers from the edge of the fabric by the fiber cutter.

2. The device of claim 1, wherein the fiber cutter includes at least one cutting element located at a cutting end of the fiber cutter.

3. The device of claim 2, wherein the cutting element includes reciprocating cutting elements.

4. The device of claim 2, wherein the fiber cutter includes a battery for powering the at least one cutting element of the fiber cutter.

5. The device of claim 1, wherein the at least one fiber cutter includes an upper fiber cutter and a lower fiber cutter respectively located above and below the fiber teaser.

6. The device of claim 1, wherein the fabric teaser comprises at least one brush element.

7. The device of claim 6, wherein the fabric teaser comprises two rotary brushes each having radially-extending bristles and arranged for receipt of the shade fabric between the bristles of the brushes.

8. The device of claim 1 further comprising a first mounting bracket and an elongated first rail, the first mounting bracket supporting the at least one fiber cutter and the fabric teaser, the first rail slidably receiving the first mounting bracket for adjusting the position of first mounting bracket along the first rail.

9. The device of claim 8 further comprising a second mounting bracket and an elongated second rail, the second mounting bracket secured to the first rail and slidably received by the second rail for adjusting the position of the second mounting bracket along the second rail.

10. The device of claim 9, wherein the second rail is substantially perpendicular to the first rail.

11. A device for removing stray fibers from a shade fabric along an edge of the shade fabric, the device comprising:
a fabric teaser including first and second rotary brushes each having a brush element and a drive motor for rotating the brush element, the brush elements of the fabric teaser having radially-extending bristles and arranged for receiving the shade fabric between the bristles of the brush elements for teasing of the stray fibers along the edge of the shade fabric by the bristles; and
upper and lower fiber cutters each having reciprocating cutting elements located at a cutting end of the fiber cutter, the fiber cutters arranged for removal of the stray fibers along the edge of the shade fabric.

12. A fabric teaser for loosening stray fibers along an edge of a shade fabric, the fabric teaser comprising:
first and second rotary brushes each having a brush element, the brush elements of the first and second rotary brushes adapted to receive the edge of the shade fabric between the brush elements, the brush elements of the first and second rotary brushes adapted to rotate in opposite rotational directions for loosening the stray fibers along the edge of the shade fabric.

13. The fabric teaser of claim 12, further comprising:
first and second drive motors coupled to the first and second rotary brushes, respectively, for rotating the brush elements of the first and second rotary brushes.

14. The fabric teaser of claim 13, further comprising:
a battery for powering the first and second drive motors.

15. The fabric teaser of claim 13, further comprising:
a power cord for connecting the first and second drive motors to an external power source for powering the first and second drive motors.

16. The fabric teaser of claim 12, wherein the first and second rotary brushes are adapted to be mounted to a bracket, such that the edge of the shade fabric may be moved through the brush elements of the first and second rotary brushes.

17. The fabric teaser of claim 16, further comprising:
at least one fiber cutter adapted to remove the stray fibers from the shade fabric.

18. The fabric teaser of claim 12, wherein the brush elements of the first and second rotary brushes have radially-extending bristles adapted for receiving the shade fabric for teasing of the stray fibers along the edge of the shade fabric by the bristles of the brush elements.

19. The fabric teaser of claim 12, wherein a tangential movement at a point of contact between the brush elements and the shade fabric is in an outward direction from the edge of the shade fabric.

20. The fabric teaser of claim 12, wherein the stray fibers are pulled away from the edge of the shade fabric when the shade fabric is received by the brush elements of the first and second rotary brushes.

21. A method of loosening stray fibers from an edge of a shade fabric, the method comprising the steps of:
rotating brush elements of two rotary brushes in opposite directions, the brush elements of the two rotary brushes mounted opposite each other; and
providing the edge of the shade fabric between the brush elements of the two rotary brushes to loosen the stray fibers along the edge of the shade fabric.

22. The method of claim 21, further comprising the step of:
cutting the stray fibers along the edge of the shade fabric after the stray fibers have been loosened by the brush elements of the two rotary brushes.

23. The method of claim 22, further comprising the step of:
moving the edge of the shade fabric through the brush elements of the two rotary brushes, such that the stray fibers are loosened and cut as the shade fabric moves.

24. The method of claim 23, wherein the step of moving the edge of the shade fabric through the brush elements of the two rotary brushes further comprises securing the shade fabric to a motor-driven roller, and rotating the motor-driven roller to move the shade fabric vertically through the brush elements of the two rotary brushes.

25. The method of claim 21, wherein the stray fibers are pulled away from the edge of the shade fabric when the edge of the shade fabric is provided between the brush elements of the two rotary brushes.
